(19) United States
(12) Patent Application Publication
(10) Pub. No.: US 2015/0139088 A1
(43) Pub. Date: May 21, 2015

(54) SYSTEM AND METHOD OF INTERFERENCE MANAGEMENT

(71) Applicants: Noam Kogan, Tel-Aviv (IL); Eran Gerson, Pardes Hana (IL); Andrey Pudeyev, Nizhny Novgorod (RU); Alexander Maltsev, Nizhny Novgorod (RU)

(72) Inventors: Noam Kogan, Tel-Aviv (IL); Eran Gerson, Pardes Hana (IL); Andrey Pudeyev, Nizhny Novgorod (RU); Alexander Maltsev, Nizhny Novgorod (RU)

(21) Appl. No.: 14/129,185

(22) PCT Filed: Dec. 17, 2012
(86) PCT No.: PCT/IB2012/003076

§ 371 Date: Dec. 24, 2013

(51) Int. Cl. H04W 72/08; H04W 24/02

(52) U.S. Cl. CPC H04W 72/082; H04W 24/02
USPC 370/329

(57) ABSTRACT

Systems, apparatuses, and methods for managing interference in a deployment of wireless devices include functionality for measuring interference in each of a plurality of available millimeter wave channels for each of a plurality of pairs of wireless devices operating in a millimeter wave band and in mutual proximity, selecting a channel for each pair of wireless devices from the plurality of available channels based on the measured interference, and transmitting data between members of each pair in the selected channel.

### TECHNICAL FIELD

This disclosure relates generally to the field of wireless connectivity, and in particular, to interference management in densely deployed wireless networks.

### BACKGROUND ART

Wireless local connectivity has become an important goal for consumer and office electronic systems. Users prefer wirelessly connected devices in order to limit the cluttered appearance of their systems. Likewise, wireless connections allow simplified build-out for office space without requiring conduits for wiring. As high bandwidth devices become more common, faster wireless connectivity is required to meet the need. In response to this demand, Wireless Gigabit (WiGig) has been proposed as a standard for communications at rates of up to 7 Gbps using the 60 GHz frequency band (millimeter wave) and including support for IEEE 802.11 communications in the 2.4 and 5 GHz bands. Millimeter wave communications may be considered generally to include transmission in the range between about 30 and about 330 GHz. The WiGig standard is intended to allow for wireless docking for portable computers, tablets and handheld devices including video transmission between devices and monitors, backup, file transfer and printer communications.

When such systems are densely placed in, for example, an enterprise cubicle environment, the multiple pairs of docking stations and laptops may tend to experience interference issues. Interference from neighboring cubicles can significantly decrease system performance.

### BRIEF DESCRIPTION OF THE DRAWINGS

FIG. 1 is a schematic diagram of a dense deployment of wireless devices in accordance with an aspect of an embodiment of the present disclosure;

FIG. 2 is a flowchart illustrating a method in accordance with an embodiment of the present disclosure; and

FIG. 3 is a flowchart illustrating a method in accordance with an embodiment of the present disclosure.

### DETAILED DESCRIPTION

In the description that follows, like components have been given the same reference numerals, regardless of whether they are shown in different embodiments. To illustrate an embodiment(s) of the present disclosure in a clear and concise manner, the drawings may not necessarily be to scale and certain features may be shown in somewhat schematic form. As used in the specification and in the claims, the singular form of “a”, “an”, and “the” include plural referents unless the context clearly dictates otherwise. Features that are described and/or illustrated with respect to one embodiment may be used in the same way or in a similar way in one or more other embodiments and/or in combination with or instead of the features of the other embodiments.

In view of the potential issues with interference in a dense device environment, the inventors have determined that it may be useful to include systems and methods for interference management. Moreover, in environments of this type, there may not always be a central router or controller that is able to select communications channels for all devices. As will be appreciated, a wireless device in communication with its associated monitor is not generally controlled by any device that is in common with its neighboring wireless device and its associated monitor. That is, the overall system may be considered architecturally as a network of peers rather than as a hierarchical network.

In an embodiment, a method for managing interference in a deployment of wireless devices includes measuring interference in each of a plurality of available millimeter wave channels for each of a plurality of pairs of wireless devices operating in a millimeter wave band and in mutual proximity, selecting a channel for each pair of wireless devices from the plurality of available channels based on the measured interference, and transmitting data between members of each pair in the selected channel.

In an embodiment, the method allows for the measuring to be performed independently for each pair of wireless devices, without information relating to other pairs of wireless devices.

In an embodiment, the method includes measuring interference in each of a plurality of available millimeter wave channels for each of a plurality of pairs of wireless devices operating in a millimeter wave band and in mutual proximity, selecting a channel for each pair of wireless devices from the plurality of available channels based on the measured interference, and transmitting data between members of each pair in the selected channel.

In a communication system in accordance with the WiGig specification, the available spectrum is divided into multiple channels. Specifically, the WiGig specification defines four channels, each 2.16 GHz wide, allowing for high rate communication, such as uncompressed video transmission. On the other hand, the short wavelengths of the 60 GHz band compared to the 2.4 GHz and 5 GHz bands of WiFi protocols results in relatively high attenuation. WiGig devices may also include transceivers adapted to make use of other wireless protocols. So-called tri-band architecture may be included, allowing communication over the two lower WiFi bands in addition to the WiGig 60 GHz band.

One solution to the attenuation issue is the application of beamforming, and in particular, adaptive beamforming, which may allow multi-gigabit communications at distances greater than 10 meters. Beamforming employs directional antennas to reduce interference and focus the signal between two devices into a concentrated “beam.” This allows faster data transmission over longer distances.

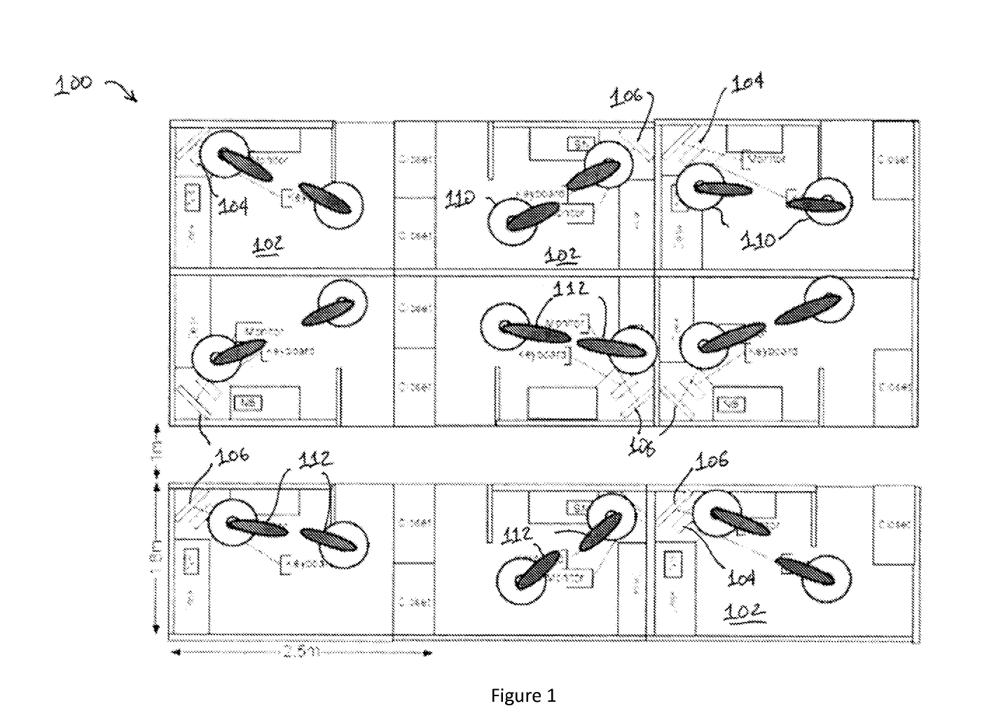

FIG. 1 is a schematic diagram illustrating a dense deployment of wireless devices. In the illustrated example, the deployment environment 100 includes a number of cubicles 102, made up of modular wall segments. Within the cubicles are devices including keyboards 104 and monitors 106. Portable computing devices (e.g., computers, laptops, tablets, handheld devices, etc.) may be disposed within the cubicle arrangement. The portable devices and the associated resources, such as the keyboards and monitors, are in wireless communication with one another. The circles 110 and lobes 112 schematically illustrate fields for the communication systems. The circular fields 110 represent omnidirectional signals/antennas while the lobes 112 represent directional (e.g., beamformed) signals/antennas.

In a deployment of this type, each pair of communicating devices may be considered as a pair of directional antennas that may operate in one of the available channels. Within the overall system, several paired transmitter and receiver groups, (e.g., docking station and PC) are deployed in different cubicles and may be operating simultaneously.

In an embodiment, a blind interference management system may be used to reduce interference between nearby pairs. This management system is based in part on application of a reciprocity principle: if any pair is subject to interference from another pair, it is likewise interfering with that pair. Therefore, moving one of the interference sources to another frequency band will eliminate interference for both pairs.

In this embodiment, there is no general controller with the authority to assign channels to all devices, therefore the management algorithm should operate independently, without receiving instructions from any higher level device. Likewise, the reciprocity principle may allow for the algorithm to operate without direct information exchange between interfering devices in the deployment. That is, the blind algorithm is configured to allow operation in which substantially all of the information used in applying the algorithm may be derived from measurements made by the individual devices.

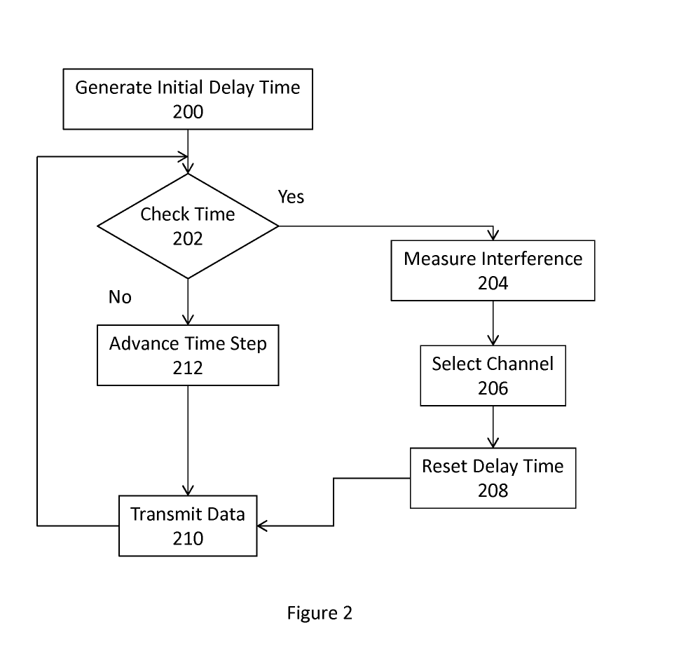

An embodiment of an algorithm in accordance with the foregoing principles is illustrated in FIG. 2. Initially, each device that initiates the transmission randomly generates an initial delay time 200, which then may be shared for both devices in a link. In the illustrated embodiment, the random delay time corresponds to a particular frame to be used as a starting point in a frame counter and the starting frame is defined according to FrameCounter=rand [0 . . . N_{frames}]. The randomized delay should generally prevent all pairs from initiating measurements simultaneously, which would tend to introduce inefficiencies and/or error in the system optimization. The number of frames N_{frames} may be a system parameter that is operator assigned, and selected to provide a good chance that random interference checks will not be simultaneous. In view of this goal, it should be understood that the larger the total number of devices, the larger N_{frames} should be. Typically, N_{frames} may be in the hundreds, though for larger systems N may be selected to be in the thousands. The larger N_{frames} is, the longer it may take for the overall system to settle into an optimized configuration. On the other hand, the smaller N_{frames} is, the more likely there is to be simultaneous measurement, which similarly affects system convergence on an optimal configuration. As will be appreciated, other mechanisms may be used to create the desired timing mismatch, such as predetermined, assigned order for devices or pairs which may be a parameter assigned during system setup.

Control proceeds to 202, where the frame counter is checked. If the frame counter has reached zero, then the device or both devices in the link at the same time measure interference 204 in each of the channels that it has available. In an embodiment, this may include all channels in only a particular frequency band (e.g., the 60 GHz band) while in alternate approaches, other available bands may be checked as well. In particular, where a device is using only a fraction of the capacity of a high bandwidth channel, it may be useful to select a channel available in a relatively lower bandwidth communications path for that device.

The duration of the measurement phase typically may be equal to several frames, and may be proportional to the N_{frames} parameter.

Once measurement is completed, the least interference channel is selected 206 for communication for that pair. In case when both devices in the link performed the interference measurements, the interference measurement results are sent to the initiating device and there the channel change decision is made for the both devices in a pair. In some embodiments, the decision may be made by maximizing the performance of the worst device in a pair. The frame counter is then reset (FrameCounter=N_{frames}) 208, and control proceeds to 210 where data is transmitted in the currently selected (newly selected) channel. The newly selected channel may be the same as the previously selected channel, where that channel measures as the least interference channel. Note that while the example illustrated makes use of a reset value equal to the max assigned for the randomization of 200, in principle these two values need not be identical and the frame counter may be set to any reasonable preselected, assigned, or random value. In principle, devices that demand the highest bandwidth may be set to have a relatively smaller count, so that they are more likely to be operating on a lowest interference channel at any given time.

If the framecounter has not reached zero at 202, then the frame counter is decremented (the time step is advanced one step) 212 and control proceeds to 210, where data is transmitted in the currently selected (previous) channel. After the time is decremented, control loops back to the check at 202 and the algorithm proceeds in this manner until the frame counter reaches zero and the measurement 204 is performed. As will be appreciated, while the example uses decrementation and a zero check, incrementation and a check against a maximum value may also be used to monitor the time state of the system.

As described above, each pair of devices implements the algorithm independently of the other pairs. As a result, each pair will change (or maintain) its selected channel (frequency band) independently. Moreover, because each pair operates on its own timing, the pairs will not generally change channels simultaneously, which tends to ensure that the interference environment is stable during the measurement phase, avoiding suboptimal band selections. In an embodiment, the system may allow for a system signal to be sent to some or all connected devices that forces a re-start of the algorithm at the beginning. Such a signal may be generated, for example, when new devices are added to the deployment, when a system operator initiates it, or after a predetermined or selectable interval.

In an alternate embodiment, a centralized approach is provided. In this embodiment, information is exchanged between devices so that an optimal channel allocation may be generated. In one approach, one of the lower band WiFi networks or a wired LAN is used for the information exchange as a separate communication path for coordination of the devices (the coordination communications channel). In an example, each cubicle contains a docking station and PC, connected via a high-speed WiGig link (the target communications channel). At the same time, the docking station may be connected to a Wi-Fi or local area network, common for all devices in the deployment. Such setup may be organized with modern communications chipsets, which support several communication bands (for example existing 802.11n standard for 2.4 GHz and 5 GHz transmissions, as well as the forthcoming 802.11ad for 60 GHz transmissions).

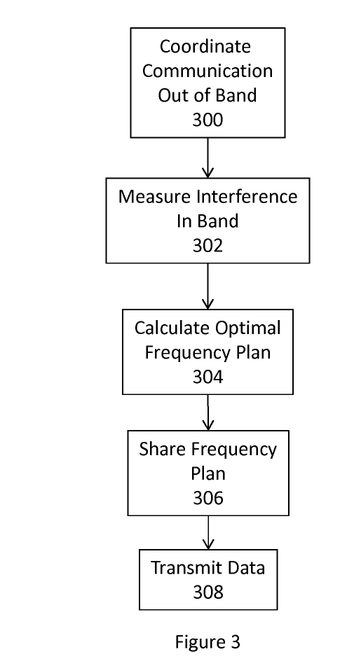

The mutual coordination between devices allows organizing precise interference measurement, for example, by switching off all but one station to measure signal power from one device to all others. With the measured values for several, or all, mutually interfering pairs in the deployment, optimal frequency planning can be calculated. The flow of the algorithm in accordance with this embodiment is illustrated in FIG. 3.

Initially, the separate communication coordination for control of devices in the area is set up 300. In the example of WiGig and WiFi, the devices are coordinated in the WiFi band for control and interference management. Once coordinated, a mutual interference measurement is made for all devices in the area 302. As described above, this measurement may be made by serially switching off all devices except one, and measuring signal power in the target communications band from that one device to all other devices. Once such signal power measurements have been made for all devices, an optimal frequency plan is calculated 304. Generally, any optimization algorithm that is applicable to multi-parameter systems may be used. As will be appreciated, suboptimal solutions may be calculated where speed of calculation is a higher priority than complete optimization. The calculated plan is then shared with the wireless devices 306 using the control channel.

Once the frequency plan is calculated, devices in the deployment communicate in accordance with the plan 308 until a triggering event occurs, causing a re-application of the algorithm. Such triggering events may be, for example, adding or removing a device from the deployment, system power reset, or a user initiated reset. For example, it may be desirable to manually force a reset when elements of the physical environment change, even where no device has been added, removed or even shifted within the deployment. For example, in a cubicle environment, wall modules may be added or removed without altering users' workstations. Because position and composition of wall modules affects signal propagation, such a change may alter the interference characteristics of the deployment space. Similarly, introduction of a device that emits RF, even if not part of the deployment, and not communicating on the primary channels, can theoretically introduce changes to interference characteristics meriting a reset.

In an embodiment, devices of a particular type may be assigned priority for preselected channels. In this approach, the priority may be used as a weighting factor in the optimization algorithm.

In an embodiment, the wireless devices include functionality for a scheduled access mode to reduce power consumption. Two devices communicating with each other via a directional link may schedule the periods during which they communicate; in between those periods, they can sleep to save power. This capability allows devices to tailor their power management to their actual traffic workload, and may be of particular use for cell phones and other handheld battery-powered devices. This scheduled communication may likewise be taken into account as part of the interference management protocol under any of the approaches described above.

As will be appreciated, the foregoing embodiments relate to wavelength division multiplexing approaches (i.e., channel management is used to allow optimized use of the spectrum). Taking advantage of the scheduled access mode, some devices in the deployment may be controlled according to access time, a time division multiplexing approach. The two approaches may be used together to further reduce interference. For example, if a particular pair has a relatively low duty cycle (i.e., its scheduled communications are rare and short), it may be assigned to a channel that has a relatively high degree of interference while high duty cycle pairs are assigned to relatively low interference channels. This approach results in a system in which the high interference channel is less used by scheduled communications, and overall load on each channel is better balanced.

Relevant wireless devices may include any device that may communicate with other devices via wireless signals in accordance with a wireless network, as discussed above. Wireless devices may, therefore include the necessary circuitry, hardware, firmware, and software or any combination thereof to effect wireless communications. Such devices may include, for example, a laptop, mobile device, cellular/smartphone, gaming device, tablet computer, a wireless-enabled patient monitoring device, personal communication system (PCS) device, personal digital assistant (PDA), personal audio device (PAD), portable navigational device, and/or any other electronic wireless-enabled device configured to receive a wireless signal. As such, wireless devices may be configured with variety of components, such as, for example, processor(s), memories, display screen, camera, input devices as well as communication-based elements. The communication-based elements may include, for example, antenna, interfaces, transceivers, modulation/demodulation and other circuitry, configured to wirelessly communicate and transmit/receive information. Wireless devices may also include a bus infrastructure and/or other interconnection means to connect and communicate information between various components and communication elements noted above.

The processor(s) of the wireless devices may be part of a core processing or computing unit that is configured to receive and process input data and instructions, provide output and/or control other components of the wireless devices in accordance with embodiments of the present disclosure. Such processing elements may include a microprocessor, a memory controller, a memory and other components. The microprocessor may further include a cache memory (e.g., SRAM), which along with the memory may be part of a memory hierarchy to store instructions and data. The microprocessor may also include one or more logic modules such as a field programmable gate array (FPGA) or other logic array.

The memory of the wireless devices may take the form of a dynamic storage device coupled to the bus infrastructure and configured to store information, instructions, and application programs to be executed by the processor(s) or controller(s) associated of the wireless P2P devices. Some or all of the memory may be implemented as Dual In-line Memory Modules (DIMMs), and may be one or more of the following types of memory: Static random access memory (SRAM), Burst SRAM or SynchBurst SRAM (BSRAM), Dynamic random access memory (DRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Enhanced DRAM (EDRAM), synchronous DRAM (SDRAM), JEDECSRAM, PCIOO SDRAM, Double Data Rate SDRAM (DDR SDRAM), Enhanced SDRAM (ESDRAM), SyncLink DRAM (SLDRAM), Direct Rambus DRAM (DRDRAM), Ferroelectric RAM (FRAM), or any other type of memory device. Wireless devices may also include read only memory (ROM) and/or other static storage devices coupled to the bus infrastructure and configured to store static information and instructions for the processor(s) and/or controller(s) associated with the wireless devices.

Having thus described the basic concepts, it will be rather apparent to those skilled in the art after reading this detailed disclosure that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure. In addition, the term “logic” is representative of hardware, firmware, software (or any combination thereof) to perform one or more functions. For instance, examples of “hardware” include, but are not limited to, an integrated circuit, a finite state machine, or even combinatorial logic. The integrated circuit may take the form of a processor such as a microprocessor, an application specific integrated circuit, a digital signal processor, a micro-controller, or the like.

Furthermore, the recited order of processing elements or sequences, or the use of numbers, letters, or other designations therefore, is not intended to limit the claimed processes and methods to any order except as is specified in the claims. Where pseudocode is used to describe algorithms, the algorithm should be understood to include other implementations and not restricted to the described pseudocode. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, as the following claims reflect, inventive embodiments lie in less than all features of a single foregoing disclosed embodiment. Thus, the claims following the detailed description are hereby expressly incorporated into this detailed description.

What is claimed is:

1. A method, comprising:
measuring interference in each of a plurality of available millimeter wave channels for each of a plurality of pairs of wireless devices operating in a millimeter wave band and in mutual proximity;
selecting a channel for each pair of wireless devices from the plurality of available channels based on the measured interference; and
transmitting data between members of each pair in the selected channel.

2. A method as in claim 1, wherein the measuring is performed independently for each pair of wireless devices, without information relating to other pairs of wireless devices.

3. A method as in claim 2, wherein, prior to the measuring, each of the pairs of wireless devices generates a random time delay, and wherein the measuring begins for each of the pairs of wireless devices after expiration of the random time delay.

4. A method as in claim 3, wherein the random time delay is selected as a random number of counts, the random number of counts being between zero and a selected maximum count.

5. A method as in claim 4, wherein the selected maximum count is selected based on a total number of wireless devices in the plurality of wireless devices.

6. A method as in claim 2, wherein the measuring is performed at different times for each of the wireless devices.

7. A method as in claim 1, further comprising, prior to the measuring, coordinating communication among the wireless devices in a control channel outside of the plurality of millimeter wave channels,
wherein the measuring comprises:
sequentially enabling transmission for a selected one of the wireless devices while disabling transmission for remaining ones of the wireless devices; and
measuring signal power from the enabled selected one of the wireless devices to each of the remaining ones of the wireless devices; and
wherein the selecting comprises calculation of a frequency plan based on the measured signal powers, and sharing the calculated frequency plan to the wireless devices using the control channel.

8. A method as in claim 7, wherein, after the selecting and sharing, the devices communicate in the selected channels until a triggering event occurs, at which time the measuring and selecting is repeated.

9. A system comprising:
a plurality of pairs of wireless devices operable in a plurality of millimeter wave channels;
the wireless devices operable to measure interference in the plurality of millimeter wave channels and to select a channel for each pair of wireless devices from the plurality of available channels based on the measured interference; and
the wireless devices operable to transmit data between members of each pair in the selected channel.

10. A system as in claim 9, wherein the devices are operable to measure the interference independently for each pair of wireless devices, without information relating to other pairs of wireless devices.

11. A system as in claim 9, wherein the devices are further operable to communicate in a control channel outside of the plurality of millimeter wave channels; and
to sequentially enable transmission for a selected one of the wireless devices while disabling transmission for remaining ones of the wireless devices; and
to measure signal power from the enabled selected one of the wireless devices to each of the remaining ones of the wireless devices; and
further comprising a controller configured and arranged to calculate a frequency plan based on the measured signal powers, and to share the calculated frequency plan to the wireless devices using the control channel.
